(19) United States
(12) Patent Application Publication
(10) Pub. No.: US 2011/0075169 A1
(43) Pub. Date: Mar. 31, 2011

(54) PRINTING APPARATUS, PRINTING APPARATUS CONTROL METHOD, AND STORAGE MEDIUM

(75) Inventor: Jun Itoh, Kawasaki-shi (JP)

(73) Assignee: CANON KABUSHIKI KAISHA, Tokyo (JP)

(21) Appl. No.: 12/890,508

(22) Filed: Sep. 24, 2010

(30) Foreign Application Priority Data
Sep. 28, 2009 (JP) 2009-223460

(51) Int. Cl. H04N 1/60

(52) U.S. Cl. 358/1.9

(57) ABSTRACT

A printing apparatus includes: an input unit configured to input images of a plurality of pages; and a printing unit configured to execute, if the images of the plurality of pages include a color page image, printing on a plurality of sheets based on the images of the plurality of pages by solely sheets for color printing even in a case where the images of the plurality of pages include a monochrome page image.

### BACKGROUND OF THE INVENTION

1. Field of the Invention

The present invention relates to an image forming apparatus which forms an image on a sheet and to an image forming method.

2. Description of the Related Art

As an image forming apparatus (e.g., a digital copying machine) forming an image on a sheet, there exists one which performs a sheet switching processing according to whether the document image that is the object of image formation is a color image or a monochrome image. For example, Japanese Patent Application Laid-Open No. 11-202689 proposes a technique in which it is determined whether a document has a color image or a monochrome image, and in which, based on the determination result, an appropriate type of sheet is automatically selected. According to this technique, even in a case where color pages and monochrome pages coexist on a plurality of document pages contained in a single printing job, it is possible to use output sheets providing images of proper quality for all pages.

However, according to the above-mentioned conventional technique, a plurality of types of sheets are automatically selected during a single print job, with the result that the processing of switching sheets to be fed takes a rather long time. On the other hand, the above-mentioned conventional technique proposes a configuration in which the user can change the type of sheets automatically selected. However, if a large amount of pages are to be printed, the user may be obliged to perform a lot of setting change operations to reduce the image forming time. Thus, it is possible that the requisite processing time including the user operation becomes rather long.

### SUMMARY OF THE INVENTION

An aspect of the present invention, a printing apparatus includes: an input unit configured to input images of a plurality of pages; and a printing unit configured to execute, if the images of the plurality of pages include a color page image, printing on a plurality of sheets based on the images of the plurality of pages by solely sheets for color printing even in a case where the images of the plurality of pages include a monochrome page image. According to the present invention, there are provided an image forming apparatus and an image forming method helping to shorten image forming time while suppressing deterioration in image forming quality.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is block diagram illustrating the configuration of an image forming apparatus according to an exemplary embodiment of the present invention.

FIG. 2 is a detailed block diagram illustrating the configuration of a control unit.

FIGS. 3A and 3B are diagrams illustrating an example of document pages.

FIG. 4 is a diagram illustrating general processing procedures for the control unit.

FIG. 5 is a detailed diagram illustrating processing procedures for an image forming processing in a first sheet feeding mode.

FIG. 6 is a detailed diagram illustrating processing procedures for an image forming processing in a second sheet feeding mode.

### DESCRIPTION OF THE EMBODIMENTS

Various exemplary embodiments, features, and aspects of the invention will be described in detail below with reference to the drawings.

In the following description, the term “color” means chromatic color. Further, the term “monochrome” means achromatic color (e.g., monochrome binary or gray scale).

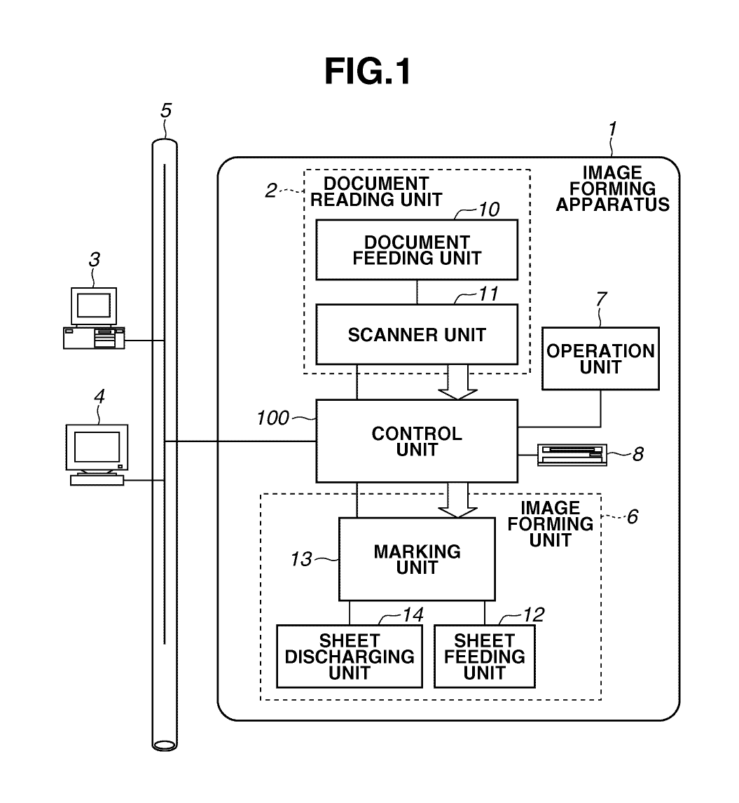

FIG. 1 illustrates the general configuration of an image forming apparatus according to an exemplary embodiment of the present invention. An image forming apparatus (data processing apparatus) 1 is connected to host computers 3 and 4 via a local area network (LAN) 5 such as Ethernet (registered trademark).

The image forming apparatus 1 includes a document reading unit 2 performing an image data reading processing, an image forming unit 6 performing an image data output processing, an operation unit 7 equipped with a keyboard performing an image data input/output operation, a liquid crystal panel displaying image data and various functions, etc., a hard disk drive 8 in which a control program, image data, etc. are previously written, and a control unit 100 connected to and controlling these components.

The document reading unit 2 has a document sheet feeding unit 10 conveying a target document sheet for reading, and a scanner unit 11 optically reading the image of the document conveyed and converting it to document image data in the form of an electric signal.

The image forming unit 6 includes a sheet feeding unit 12 equipped with sheet feeding cassettes of a plurality of stages accommodating a plurality of kinds and sizes of sheets serving as output media, a marking unit 13 transferring and fixing image data to a sheet, and a sheet discharge unit 14 for performing sorting and stapling on a printed sheet and discharging it to the outside.

The control unit 100 is configured with a single electronic component, and has at least a scanner function to convert image data read by the document reading unit 2 into codes and transmit the same to the host computers 3 and 4 via the LAN 5, and an image forming function to convert the code data received from the host computers 3 and 4 via a LAN 5 and output the same to the image forming unit 6. The control unit 100 functions as a control unit controlling the sheet feeding unit 12.

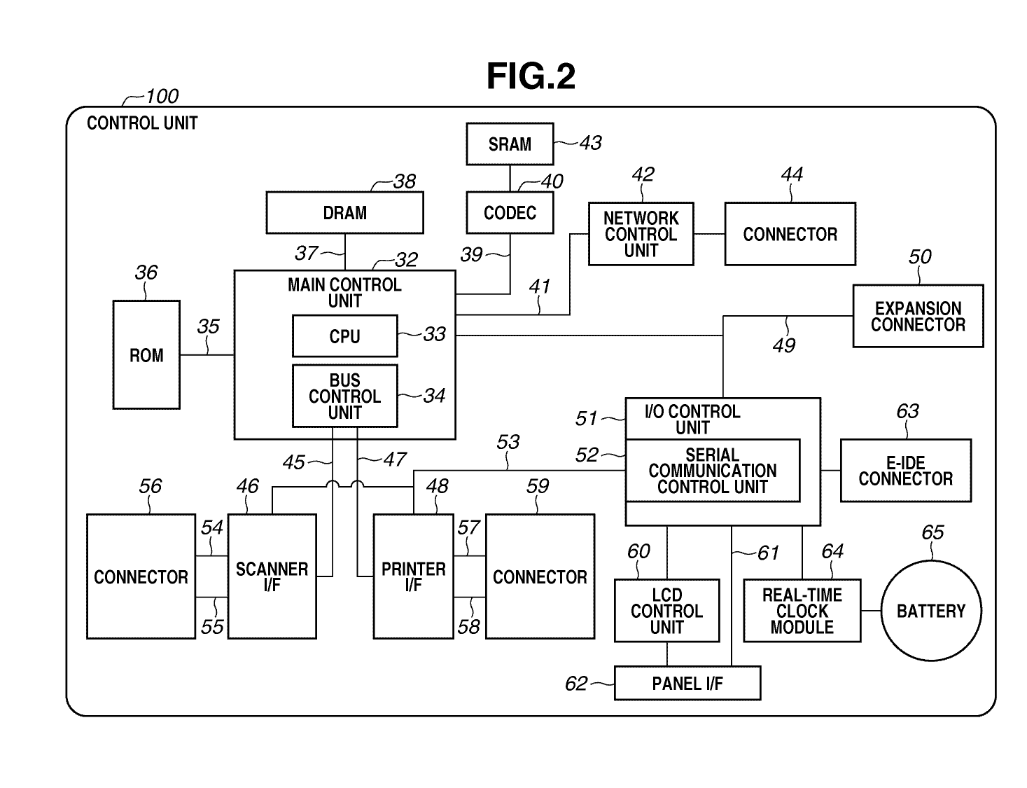

FIG. 2 illustrates in detail the configuration of the control unit 100. A main control unit 32 has a central processing unit (CPU) 33, a bus control unit 34, and a function block including various control circuits described below, and is connected to a read-only memory (ROM) 36 via a ROM interface (I/F) 35, to a dynamic random access memory (DRAM) 38 via a DRAM I/F 37, to a codec 40 via a codec I/F 39, and to a network control unit 42 via a network I/F 41.

The ROM 36 stores various control programs executed by the CPU 33 of the main control unit 32 and calculation data. The DRAM 38 is used as an operational region for the operation of the CPU 33 and as a region for accumulating image data.

The codec 40 compresses raster image data accumulated in the DRAM 38 by a well-known compression system such as modified-Huffman/modified-READ/modified-modified-READ/joint-bi-level-image-experts-group (MH/MR/MMR/JBIG), and the compressed data is expanded into raster image. Further, a static random access memory (SRAM) 43 is connected to the codec 40. The SRAM 43 is used as a temporary operational region for the codec 40. The network control unit 42 performs a predetermined control operation between itself and the LAN 5 via a connector 44.

The main control unit 32 is connected to a scanner I/F 46 via a scanner bus 45, to a printer I/F 48 via a printer bus 47, and, further, to an extension connector 50 for connecting an extension board and to an input/output control unit (I/O control unit) 51 via a general-purpose fast bus 49 such as a Peripheral Component Interconnect (PCI) bus.

In the I/O control unit 51, there is provided a 2-channel asynchronous serial communication control unit 52 for transmitting and receiving a control command between itself and the document reading unit 2 and the image forming unit 6, and the serial communication control unit 52 is connected to a scanner I/F 46 and a printer I/F 48 via an I/O bus 53.

The scanner I/F 46 is connected to a scanner connector 56 via an asynchronous serial I/F 54 and a video I/F 55, and the scanner connector 56 is connected to the scanner unit 11 of the document reading unit 2. The scanner I/F 46 performs a desired binarization processing and a zooming processing in a main scanning direction and a sub scanning direction on image data received from the scanner unit 11. Further, it produces a control signal based on a video signal transmitted from the scanner unit 11, and transmits it to the main control unit 32 via the scanner bus 45.

The printer I/F 48 is connected to a printer connector 59 via an asynchronous serial I/F 57 and a video I/F 58, and the printer connector 59 is connected to a marking unit 13 of the image forming unit 6. The printer I/F 48 performs smoothing processing on the image data output from the main control unit 32, and outputs it to the marking unit 13. Further, it outputs a produced control signal to the printer bus 47 based on a video signal transmitted from the marking unit 13.

The CPU 33 operates based on a control program read from the ROM 36 via the ROM I/F 35. For example, it interprets page-description language (PDL) data received from the host computers 3 and 4, and performs expansion processing into the raster image data.

The bus control unit 34 controls the transmission of data input and output to and from an external apparatus connected to the scanner I/F 46, the printer I/F 48, the extension connector 50, etc., and controls arbitration at the time of bus competition and the transmission of direct memory access (DMA) data. For example, the data transmission between the DRAM 38 and the codec 40, the data transmission from the scanner unit 11 to the DRAM 38, the data transmission from the DRAM 38 to the marking unit 13, etc. are controlled by the bus control unit 34 to effect DMA transmission.

The I/O control unit 51 is connected, via a liquid crystal display (LCD) control unit 60 and a key input I/F 61, to a panel I/F 62, which is connected to the operation unit 7. The I/O control unit 51 is connected to an electrically erasable programmable ROM (EEPROM) 66 as non-volatile memory, and is further connected to the hard disk drive 8 via an Enhanced Integrated Drive Electronics (E-IDE) connector 63. Further, it is connected to a real-time clock module 64 updating/retaining date and time managed within the apparatus. The real-time clock module 64 is connected to a back-up battery 65 to be backed-up by the back-up battery 65.

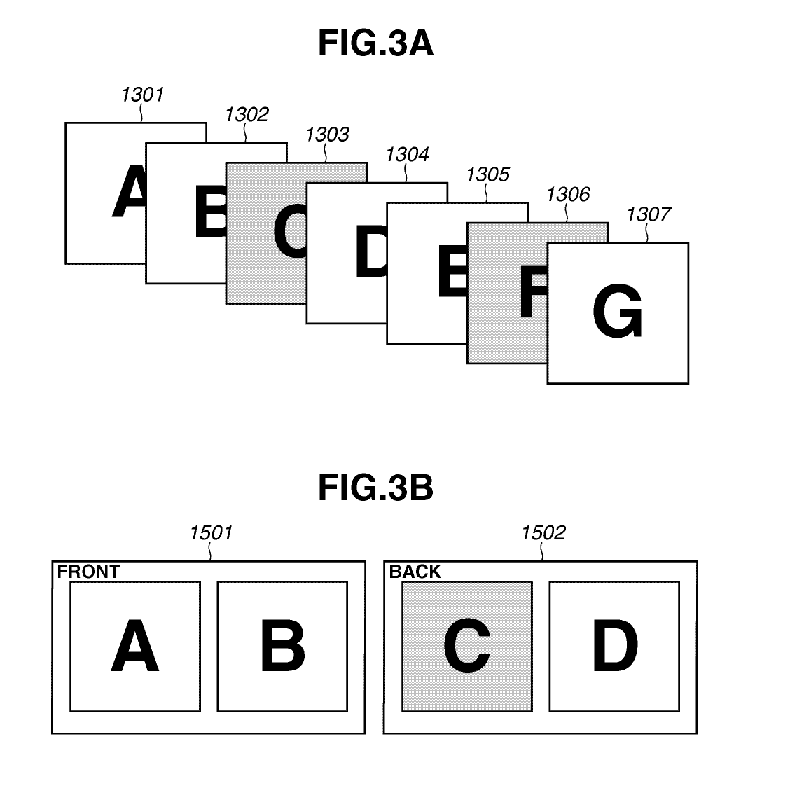

FIG. 3A shows a plurality of document images in which color images and monochrome images coexist. The color image pages are indicated by numerals 1303 and 1306. The rest are monochrome image pages. In some cases, each one of these document image pages (hereinafter referred to as the document pages) undergo image formation on a single sheet basis. In other cases, a plurality of pages are arranged on a single sheet and undergo image formation in this state. More specifically, the image forming apparatus of the present exemplary embodiment includes a setting unit setting the number of document image pages to be formed on each sheet.

FIG. 3B shows an example in which two document pages are arranged on each of a front surface 1501 and a back surface 1502 of a single sheet. In the image forming apparatus of the present exemplary embodiment, the user can select either a first sheet feeding mode in which the kind of sheet onto which image formation data is to be output is switched for each sheet according to the characteristics of the document image data, or a second sheet feeding mode in which only sheets of a specific kind are fed without respect to the characteristics of the document image data.

When the first sheet feeding mode is selected by the user, the kind of sheet to be used is selected according to whether the document page arranged on each sheet is monochrome or color. In a case where a plurality of document pages are printed on a single sheet, when all the document pages arranged on the single sheet are monochrome, a sheet for monochrome image formation (second kind of sheet) is selected, and, when there exists at least one color document page, a sheet for color image formation (first kind of sheet) is selected. In FIG. 3B, of the document pages, two of which are respectively arranged on each of the front surface 1501 and the back surface 1502. Since the document page C on the back surface 1502 is a color document image, a sheet for color image formation is selected, with the images being formed at the positions where the document pages are arranged.

In a case where the second sheet feeding mode is selected by the user, when there exists at least one color document page in all the document pages, sheets for color image formation are selected as the sheets for the image formation of all the document pages, and when all the document pages are monochrome images, there are selected sheets for monochrome image formation as the sheets for the image formation of all the document pages.

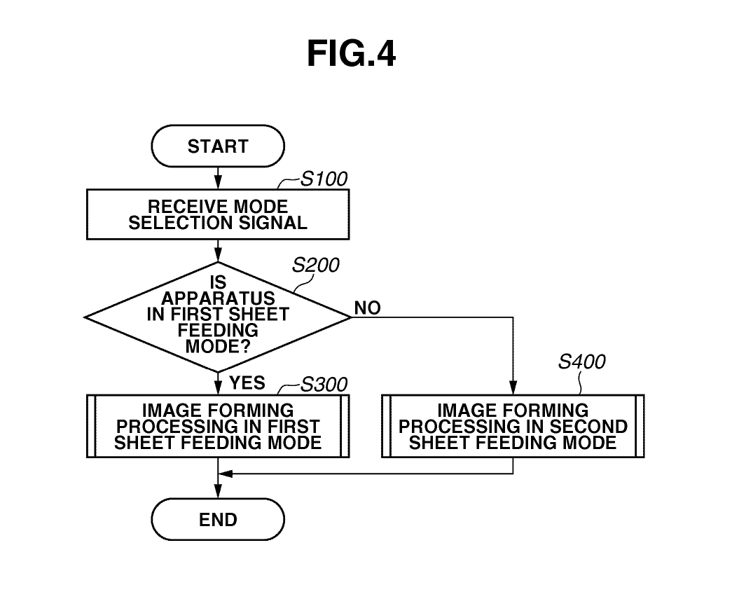

FIG. 4 illustrates the general processing procedures for the control unit 100. First, when the user selects one of the sheet feeding modes through the operation of the operation unit 7, the control unit 100 receives a mode selection signal indicating the selected sheet feeding mode (step S100). Next, the control unit 100 determines whether the mode selection signal received in step S100 is a signal indicating the first sheet feeding mode or not (step S200). In the case of a signal indicating the first sheet feeding mode (YES in step S200), an image forming processing in the first sheet feeding mode (step S300) is executed. When the signal is not one indicating the first sheet feeding mode but one indicating the second sheet feeding mode (NO in step S200), an image forming processing in the second sheet feeding mode (step S400) is executed, thus completing a series of processing operations.

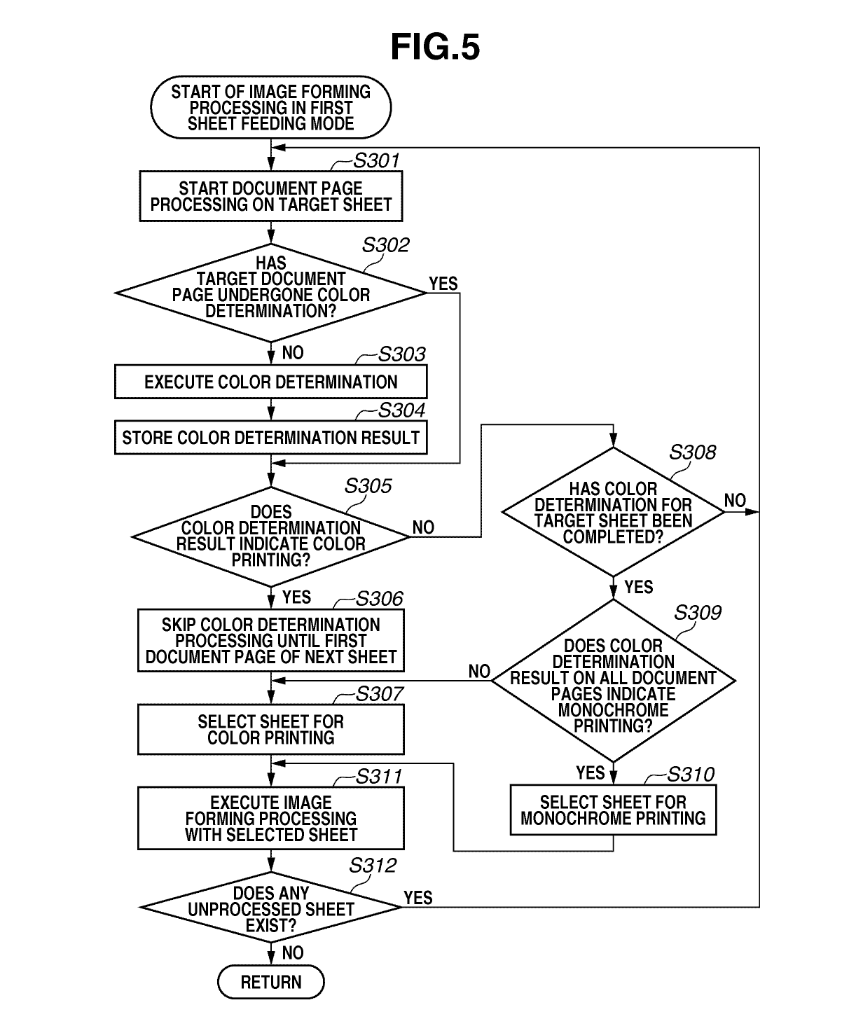

FIG. 5 illustrates in detail the image forming processing in the first sheet feeding mode (S300). First, the control unit 100 starts processing on the document pages arranged on the target sheet for the processing (step S301). In this processing, printing is executed based on the images of a plurality of pages input from the scanner unit 11, and the images of a plurality of pages input via the network 5. The control unit 100 decides whether color determination (add compare select (ACS) determination) as to whether the document page of the first page arranged on the sheet concerned is color or monochrome has been executed, and whether the determination result is stored on the hard disk 8 (step S302). More specifically, based on the page arrangement on the sheet concerned, the page range of the image formation data output to the sheet is recognized, and it is sequentially determined whether the image formation data of the recognized page range includes color image data. In the case where it has been executed (YES in step S302), the procedure advances to the checking of the determination result (step S305). When it has not been executed (NO in step S302), the control unit 100 executes color determination on the document page (step S303), and stores the determination result on the hard disk 8 (step S304).

Next, the control unit 100 determines whether the color determination result indicates color printing (step S305). When the color determination result indicates color printing (YES in step S305), the control unit 100 determines that a sheet for color image formation should be used as the target sheet for the processing. Thus, there is no need to execute color determination on the other document pages arranged on the target sheet for the processing, so that the control unit 100 skips the target document page for the processing up to the first document page to be printed on the next sheet (step S306). After this, the control unit 100 selects a sheet for color image formation (step S307), and causes the image forming unit 6 to execute image forming processing by using the selected sheet (step S311). More specifically, the image forming processing is executed in step S311 by using solely the sheet feeding stage storing the selected kind of sheet from the sheet feeding cassettes of a plurality of stages in the sheet feeding unit 12.

When it is determined in step S305 that the color determination result indicates monochrome printing (NO instep S305), the control unit 100 determines whether color determination has been completed on all the document pages arranged on the target sheet for the processing (step S308). When there exists a document page that has not undergone color determination (NO in step S308), the control unit 100 executes color determination on the unprocessed document pages starting from step S301. In the case where color determination has been completed on all the document pages (YES in step S308), the control unit 100 determines whether all the document pages arranged on the target sheet for the processing are monochrome (step S309). When they are all monochrome (YES in step S309), the control unit 100 determines that a sheet for monochrome printing should be used as the target sheet for the processing (S310), and causes the image forming unit 6 to execute image formation by using the selected sheet (step S311). More specifically, in step S311, the image forming processing is executed by using solely the sheet feeding stage with the selected kind of sheets of the sheet feeding cassette of a plurality of stages in the sheet feeding unit 12. And, the control unit 100 determines whether there exists a target sheet for the processing (step S312). When there exists a target sheet for the processing (YES in step S312), the control unit 100 changes the object of the processing to the sheet for the next processing, and resumes processing starting from step S301. The control unit 100 determines whether the image formation has been completed on all the sheets. When it is determined that the image formation has been completed on all the sheets, the processing is ended.

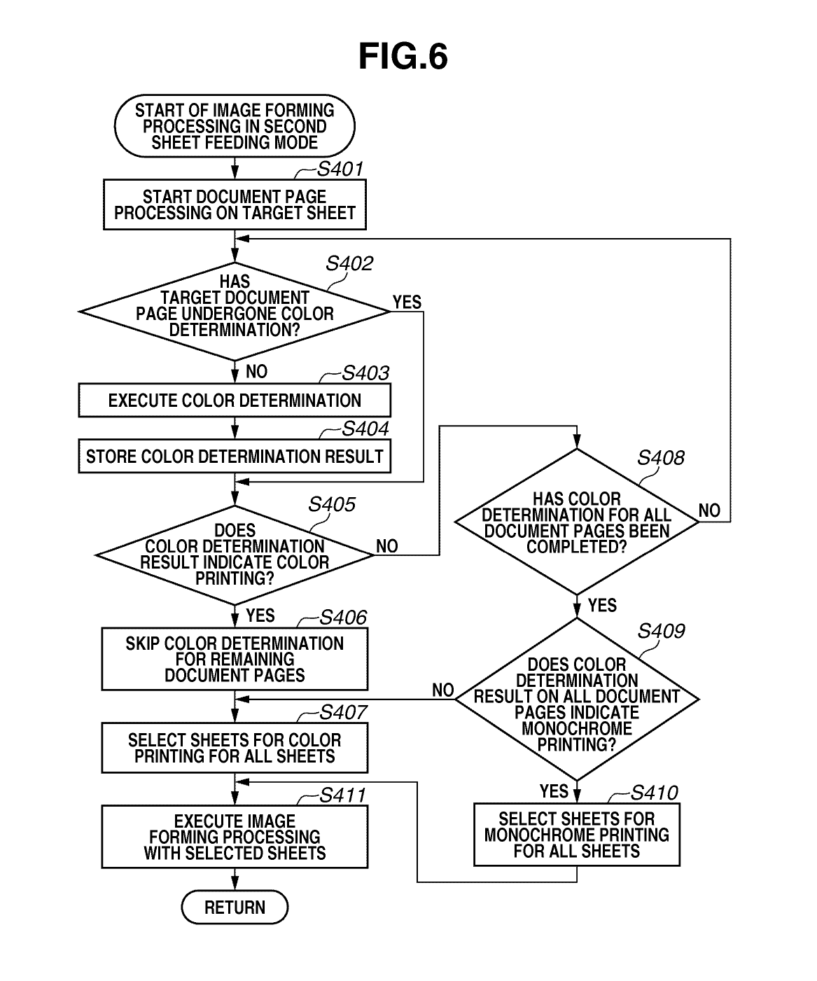

FIG. 6 illustrates in detail the processing procedures of the image forming processing in the second sheet feeding mode (step S400). First, the control unit 100 starts the processing on the document pages arranged on the target sheet for the processing (step S401). In this processing, printing is executed based on the images of a plurality of pages input from the scanner unit 11 and the images of a plurality of pages input via the network 5. The control unit 100 determines whether color determination has been executed on the document pages arranged on the sheet and whether the determination result is stored on the hard disk 8 (step S402). In the case where the color determination has been executed (YES in step S402), the procedure advances to the checking of the determination result (step S405). When the color determination has not been executed (NO in step S402), the control unit 100 executes color determination on the document pages (step S403), and stores the color determination result on the hard disk 8 (step S404).

Next, the control unit 100 determines whether the color determination result indicates color printing (step S405). When the color determination result indicates color printing (YES in step S405), there is no need to execute color printing on all the unprocessed document pages, so that the control unit 100 skips the color determination processing on the remaining document pages (step S406), and selects the use of sheets for color image formation (step S407). Finally, the control unit 100 causes the image forming unit 6 to execute the image formation of all the document pages on the selected sheets (step S411), and ends the processing. More specifically, in step S411, the image forming processing is executed by using solely the sheet feeding stage with the selected kind of sheet from the sheet feeding cassettes of a plurality of stages in the sheet feeding unit 12. In other words, based on the set page number for each sheet, the page range of image formation data output to each sheet is recognized, and it is sequentially determined whether the image formation data of the recognized page range includes color image data. When it is determined that color image data is included, the determination processing is completed, and, when the determination processing is completed, the image forming processing is started.

On the other hand, when it is determined in step S405 that the color determination result indicates monochrome printing, the control unit 100 determines whether the color determination has been completed on all the document pages (step S408). When there exits a page on which no color determination has been executed (NO in step S408), color determination is executed on the unprocessed document pages starting from step S402. When the color determination has been completed on all the document pages (YES in step S408), the control unit 100 determines whether all the target document pages for the processing are monochrome (step S409). When all the document pages are monochrome (YES in step S409), the control unit 100 selects sheets for monochrome printing (step S410). Finally, the control unit 100 causes the image forming unit 6 to execute image formation of all the document pages on the selected sheets (step S411) to thereby end the processing. That is, in step S411, the image forming processing is executed by using solely the sheet feeding stage with the selected kind of sheet from the sheet feeding cassette of the plurality of stages in the sheet feeding unit 12.

As described above, according to the present exemplary embodiment, it is possible to perform image forming processing through automatic selection of a sheet of the optimum kind according to whether color image formation data exists in the image formation data included in a single image forming job. Further, by storing the result of color determination once executed and by effecting sheet switching from this processing onward using the color determination result, it is possible to suppress a reduction in the processing speed. Further, according to the present exemplary embodiment, the user can select either the first sheet feeding mode or the second sheet feeding mode, so that it is possible to provide an image forming apparatus which allows the user to make priority selection in terms of image forming time, image forming quality, or image forming cost.

### Other Embodiments

Aspects of the present invention can also be realized by a computer of a system or apparatus (or devices such as a CPU or MPU) that reads out and executes a program recorded on a memory device to perform the functions of the above-described embodiment (s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium)

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2009-223460 filed Sep. 28, 2009, which is hereby incorporated by reference herein in its entirety.

What is claimed is:

1. A printing apparatus comprising:
an input unit configured to input images of a plurality of pages; and
a printing unit configured to execute, if the images of the plurality of pages include a color page image, printing on a plurality of sheets based on the images of the plurality of pages solely by sheets for color printing even in a case where the images of the plurality of pages include a monochrome page image.

2. The printing apparatus according to claim 1, wherein the printing unit executes printing on a plurality of sheets based on the images of the plurality of pages solely by sheets for monochrome printing in a case where all the images of the plurality of pages are monochrome page images.

3. The printing apparatus according to claim 1, further comprising a determination unit determining whether each of the images of the plurality of pages is a color page image or a monochrome page image,
wherein the printing unit executes the printing according to the determination result obtained by the determination unit.

4. The printing apparatus according to claim 3, wherein, in a case where the determination unit determines that the images of one page are color page images, the printing unit executes printing on a plurality of sheets based on the images of the plurality of pages solely by sheets for color printing without waiting for the determination unit to execute determination on the images of the remaining pages.

5. The printing apparatus according to claim 1, wherein the printing apparatus has a plurality of sheet feeding units, and
wherein, when executing printing by using sheets of a specific type, the printing unit uses solely a sheet feeding unit storing the sheets of the specific type from the plurality of sheet feeding units.

6. A method of controlling a printing apparatus, comprising:
inputting images of a plurality of pages; and
executing, if the images of the plurality of pages include a color page image, printing on a plurality of sheets based on the images of the plurality of pages solely by sheets for color printing even in a case where the images of the plurality of pages include a monochrome page image.

7. A computer-readable storage medium storing a control program for causing a computer to perform operations comprising:
inputting images of a plurality of pages; and
executing, if the images of the plurality of pages include a color page image, printing on a plurality of sheets based on the images of the plurality of pages by solely sheets for color printing even in a case where the images of the plurality of pages include a monochrome page image.
